(19) United States
(12) Patent Application Publication
(10) Pub. No.: US 2022/0343141 A1
(43) Pub. Date: Oct. 27, 2022

(54) CAVITY FILTER TUNING USING IMITATION AND REINFORCEMENT LEARNING

(71) Applicant: Telefonaktiebolaget LM Ericsson (publ), Stockholm (SE)

(72) Inventors: Xiaoyu LAN, Täby (SE); Simon LINDSTAHL, Älvsjö (SE)

(73) Assignee: Telefonaktiebolaget LM Ericsson (publ), Stockholm (SE)

(21) Appl. No.: 17/614,433

(22) PCT Filed: May 27, 2020
(86) PCT No.: PCT/SE2020/050534

§ 371 Date: Nov. 26, 2021

Related U.S. Application Data
(60) Provisional application No. 62/853,403, filed on May 28, 2019.

(51) Int. Cl. G06N 3/04; H01P 1/207

(52) U.S. Cl. CPC G06N 3/0454; H01P 1/207

(57) ABSTRACT

A method for solving a sequential decision-making problem is provided. The method includes gathering state-action pair data from an expert policy; applying imitation learning to yield a cloned policy based on the gathered state-action pair data from the expert policy; and applying a reinforcement learning technique, wherein the reinforcement learning technique is initialized based on the cloned policy and has an output with one or more action to be performed for solving the sequential decision-making problem.

### CROSS REFERENCE TO RELATED APPLICATION

This application is a 35 U.S.C. § 371 National Phase Entry application from PCT/SE2020/050534, filed May 27, 2020, designating the United States, which claims priority to U.S. provisional patent application No. 62/853,403, filed May 28, 2019, the disclosures of which are incorporated herein by reference in their entirety.

### TECHNICAL FIELD

Disclosed are embodiments related to improving cavity filter tuning using imitation and reinforcement learning.

### BACKGROUND

Cavity filters are mechanical filters that are commonly used in 4G and 5G radio base stations. There is a great demand for such cavity filters, e.g. given the growing trend of the internet of things and the connected society. During the production process of cavity filters, there are always physical deviations in the cavities and cross couplings of the filter, which requires the filter to be tuned manually to make the magnitude responses of the scattering parameters fit some specifications. This manual tuning requires an expert's experience and intuition to adjust the screw positions on the filter and is therefore costly and time consuming, and also prevents the manufacturing process from being fully automated.

Reinforcement learning is a technique to solve sequential decision-making problems. It models the problem into a Markov decision process (MDP) where an agent interacts with an environment to receive (state, reward) and acts back to achieve high accumulative long-term rewards. Deep reinforcement learning with deep neural networks as a function approximator has recently successfully dealt with learning how to play Atari games on a human level, beating human masters at the game of Go and even showed some promise in use for tuning of cavity filters.

Imitation learning is a powerful and practical alternative to reinforcement learning for learning sequential decision-making policies using demonstrations. Imitation learning learns how to make sequences of decisions in an environment, where the training signal comes from demonstrations. Imitation learning has been widely used in robotics and auto-driving.

### SUMMARY

While imitation learning is useful in many circumstances (in particular, it is far more sample efficient than Reinforcement Learning), it has the obvious drawback of being unable to outperform its “parent” (expert) policy. Thus, any imperfections of the parent are carried over to the child. Reinforcement Learning has no such limitations, but it is extremely sample inefficient. By utilizing imitation learning as an initialization for a Reinforcement Learning (RL)-technique it should, in principle, be possible to combine the best of both, or at least create a technique which can outperform the parent policy faster than any reinforcement learning technique.

Some attempts at automating cavity filter tuning have been made, though each such attempt has had deficiencies. For example, systems may only tune the cavity filter to satisfy the S₁₁ parameters (return loss) without regard for the other Scattering (S−) parameters. One system has used neural networks to determine how to turn the screws of a cavity filter, by manually tuning a filter and then learning the deviations in screw positions of all screws in the filter as a function of the S-parameters. However, the system only considered return loss requirements and only predicted deviations of the frequency screws, assuming the coupling and cross-coupling screws were already well-tuned.

Embodiments disclosed herein model filter tuning with an imitation and reinforcement learning technique, which first performs imitation learning iterations with data from one well-trained expert filter tuning model. Then the weights of the trained imitation policy are used in a policy gradient reinforcement learning method which gives output with action of all screws being tuned in each step. Finally, a screw selector is trained using reinforcement learning to allow only one screw to be tuned at a time.

Embodiments have several advantages. For example, the performance of the imitation and reinforcement learning agent is better than a well-trained expert model as it uses expert policy as the initial policy. Thus, it can outperform a well-trained expert model with a higher tuning success rate and fewer adjustment steps which leads to shorter total tuning time. Additionally, the imitation and reinforcement learning based cavity filter tuning model of embodiments has been applied in a simulation environment and could tune cavity filters with more screws and satisfy both S₁₁ and S₂₁ parameters (return loss and insertion loss) and tuned both coupling and cross-coupling, improving upon prior art solutions.

According to a first aspect, a method for solving a sequential decision-making problem is provided. The method includes gathering state-action pair data from an expert policy. The method further includes applying imitation learning to yield a cloned policy based on the gathered state-action pair data from the expert policy. The method further includes applying a reinforcement learning technique, wherein the reinforcement learning technique is initialized based on the cloned policy and has an output with one or more action to be performed for solving the sequential decision-making problem.

In some embodiments, the imitation learning comprises a behavioral cloning technique. In some embodiments, the sequential decision-making problem for solving comprises cavity filter tuning and the method and the method further includes applying a screw selector for tuning a screw in a cavity filter. In some embodiments, the screw selector comprises a Deep Q Network (DQN). In some embodiments, the expert policy is based on Tuning Guide Program (TGP). In some embodiments, the cloned policy is in the form of a neural network, wherein the deepest hidden layer is convolutional in one dimension.

In some embodiments, the reinforcement learning technique comprises the Deep Deterministic Policy Gradient (DDPG) technique. In some embodiments, an output of the reinforcement learning technique is forced via a multiplied tanh function. In some embodiments, applying the reinforcement learning technique comprises allowing the reinforcement learning technique to run for N_{critic} iterations where only the critic network is trained, with no change to the actor network or target network, and after the N_{critic} iterations, allowing the technique to run to convergence. In some embodiments, the method further includes performing the one or more actions of the output of the reinforcement learning technique

According to a second aspect, a node for solving sequential decision-making problems is provided. The node includes a data storage system. The node further includes a data processing apparatus comprising a processor. The data processing apparatus is coupled to the data storage system, and the data processing apparatus is configured to gather state-action pair data from an expert policy. The data processing apparatus is further configured to apply imitation learning to yield a cloned policy based on the gathered state-action pair data from the expert policy. The data processing apparatus is further configured to apply a reinforcement learning technique, wherein the reinforcement learning technique is initialized based on the cloned policy.

According to a third aspect, a node for solving sequential decision-making problems is provided. The node includes a gathering unit configured to gather state-action pair data from an expert policy. The node further includes an imitation learning unit configured to apply imitation learning to yield a cloned policy based on the gathered state-action pair data from the expert policy. The node further includes a reinforcement learning unit configured to apply a reinforcement learning technique, wherein the reinforcement learning technique is initialized based on the cloned policy.

According to a fourth aspect, a computer program is provided comprising instructions which when executed by processing circuitry of a node causes the node to perform the method of any one of the embodiments of the first aspect.

According to a fifth aspect, a carrier is provided containing the computer program of the fourth aspect, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a box diagram with a reinforcement learning component.

FIG. 2 illustrates an example of the tuning process of the cavity filter with a trained reinforcement learning agent according to an embodiment.

FIG. 3 illustrates a block diagram of the imitation learning and reinforcement learning technique, also showing the screw selector according to an embodiment.

FIG. 4 is a flow chart according to an embodiment.

FIG. 5 is a block diagram of an apparatus according to an embodiment.

FIG. 6 is a block diagram of an apparatus according to an embodiment.

### DETAILED DESCRIPTION

An example of an intelligent filter tuning technique using a common reinforcement learning technique follows. Filter tuning as an MDP can be described as follows.

State: The S-parameters are the state. The S-parameters are frequency dependent, i.e. S=S(f). For a two-ports filter we have S-parameters S₁₁; S₁₂; S₂₁; S₂₂. The S-parameters may be the output of a Vector Network Analyzer, which displays S-parameter curves. The input of the observations to the artificial neural networks (ANNs) of the policy function and the Q-network for a single observation may be a real-valued vector including the real and imaginary parts of all the components of the S-parameters. Every MHz in a range between 850 and 950 MHz was sampled and attended to a vector with 400 elements.

Action: Tuning the cavity filter. For example, a 6p2z type filter has 13 adjustable screws each with a continuous range [−90°; 90° ]. One or more of the screws may be adjusted for tuning purposes.

Reward: Agent will receive a positive reward (e.g. +100 reward) if the state satisfies the design specification, otherwise, a negative reward is incurred depending on the distance to the tuning specifications. This shaped reward function may be heuristically designed by human intuition and does not necessarily lead to an optimal policy for problem solving. An example follows:

$${d}_{11} ( f ) = \{ \begin{matrix}0 , if {s}_{11} ( f ) satisfies the design spec \\ \vert {s}_{11} ( f ) - {s}_{11}^{spec} ( f ) \vert , otherwise\end{matrix}$$

$${d}_{21} ( f ) = \{ \begin{matrix}0 , if {s}_{21} ( f ) satisfies the design spec \\ \vert {s}_{21} ( f ) - {s}_{21}^{spec} ( f ) \vert , otherwise\end{matrix}$$

Here s₁₁^{spec}(f) and s₂₁^{spec}(f) are the lower or upper bound of the design specifications. Then the total reward for a state s becomes:

$$r ( s ) = \{ \begin{matrix}100 , & if solved \\ - {\sum }_{f} ( {d}_{11} ( f ) + {d}_{21} ( f ) ) , & otherwise\end{matrix}$$

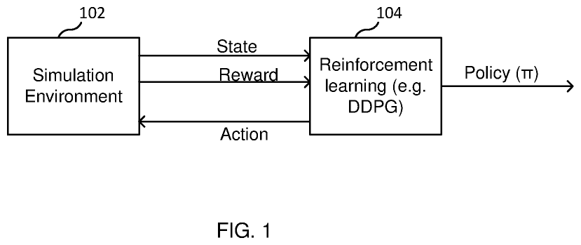

The reinforcement learning technique used may be the Deep Deterministic Policy Gradient (DDPG) technique. Simulation results using the DDPG technique show that the agent could find a good policy after sampling about 149,000 data points with the best available hyper-parameters. FIG. 1 illustrates a box diagram with a reinforcement learning component 104, showing (state, reward) input to the reinforcement learning component 104, which interacts with the environment 102 with actions, resulting in a policy π.

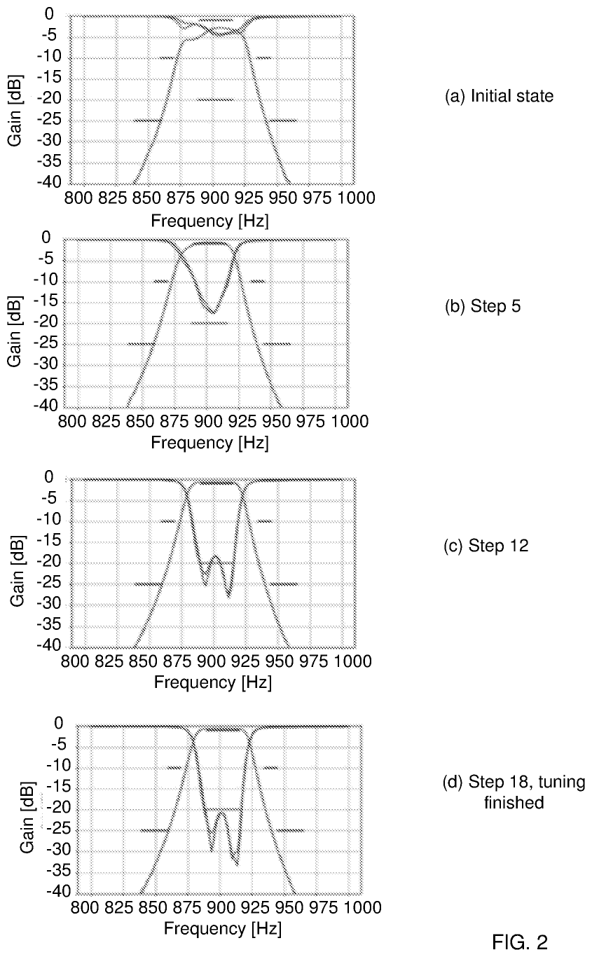

FIG. 2 illustrates an example of the tuning process of the cavity filter with a trained reinforcement learning agent. The tuning specifications are also visible. In the beginning, the curves are quite far off from the design specifications and in the consecutive images the filter is closer to being tuned until step 18 when the tuning process is finished.

Tuning Guide Program (TGP) is one prominent example of an automatic tuning technique. By calculating the return loss curve which best matches a Chebyshev polynomial within the passband, within the feasible set of the current filter model, TGP can calculate the optimal positions of the screws and thereby provide recommendations for how to tune each screw. As the true filter may not match the model, TGP updates its estimate of the feasible set in each iteration until the filter is tuned.

TGP is (as of the time of writing) state-of-the-art on the problem of automatic cavity filter tuning. On a 6p2z environment, for example, TGP is able to tune filters with an accuracy of 97% and, on average 27 screw adjustments. The accuracy, in this case, refers to the probability that the filter will be tuned within 100 adjustments when initialized randomly. Embodiments disclosed herein build upon learning from expert data, such as that gathered by running TGP. Accordingly, embodiments herein provide solutions to the following two problems: (1) With as few data points as possible, how to ensure that the trained policy has a significantly better accuracy than the expert data (e.g. TGP); and (2) With as few data points as possible, how to ensure that the trained policy, on average, uses significantly fewer screw adjustments than the expert data (e.g. TGP), while maintaining the same or substantially similar accuracy.

In order to address the two issues identified above, embodiments herein provide an imitation-reinforcement learning technique, such as detailed below.

As a first step, state-action pair data is gathered with an expert policy (such as provided by TGP). An expert policy refers to a known policy which is desired to be improved, such as a policy where actions are chosen by a source of expert knowledge (e.g., a human expert that manually selects actions), or a policy that is known to have decent performance (e.g., TGP in the case of tuning cavity filters). After this, behavioral cloning may be performed on the expert policy, yielding a cloned policy. The expert policy and/or cloned policy may take the form of a neural network, where the deepest hidden layer is convolutional in one dimension. Convolutional layers in a neural network convolve (e.g., with a multiplication or other dot product) the input and pass its result to the next layer.

In order to improve the performance on the policy obtained with imitation learning, a reinforcement learning technique is employed. The reinforcement learning technique may employ an actor-critic network, i.e. an actor neural network and a critic neural network. An actor-critic network (such as DDPG), utilizes an actor network and a critic network, where the actor (neural) network is used to select actions, and the critic (neural) network is used to criticize the actions made by the actor, where the criticism by the critic network iteratively improves the policy of the actor network. A target network may also be used, which is similar to the actor network and initialized to the actor network, but is updated more slowly than the actor network, in order to improve convergence speed. In embodiments, the DDPG technique may be used, where an actor network is initialized with the weights of an imitation policy, as trained in the previous steps. To maintain consistency with an imitator network, the output may be forced (e.g., via a multiplied tanh function) to be within the interval [−bₐ, bₐ]. In order to have a well-initialized critic network, the reinforcement learning technique (e.g., DDPG) may be allowed to run for N_{critic} iterations where only the critic network was trained, with no change to the actor network or target network. After this, the technique is allowed to run to convergence.

In some embodiments, a screw selector (such as one using a Deep Q Network (DQN)) may be used. For example, when using DDPG, it can necessitate that all screws must be turned in every step to converge. This property is suboptimal for minimizing or reducing the number of adjustments needed. A screw selector may be trained (e.g. using DQN), to allow the technique to tune only one screw at a time. In embodiments, anywhere from one screw to all the screws may be adjusted on a given step.

For example, the screw selector may be trained in the following manner. In every step, S-parameter data is gathered and a trained reinforcement learning actor network (for instance the one from the steps above), predicts an action to be performed for every screw. Both of these (the S-parameter data and the action for every screw) are fed into a fully connected neural network, which predicts Q-values (a cumulative reward value, short for Quality Value) for each screw. When trained, the agent then tunes the screw with the highest predicted Q-value with the amount predicted by the DDPG actor network for that particular screw. The Q-network (part of the Deep Q Network (DQN) technique) is trained using DQN with an s-decay exploration scheme.

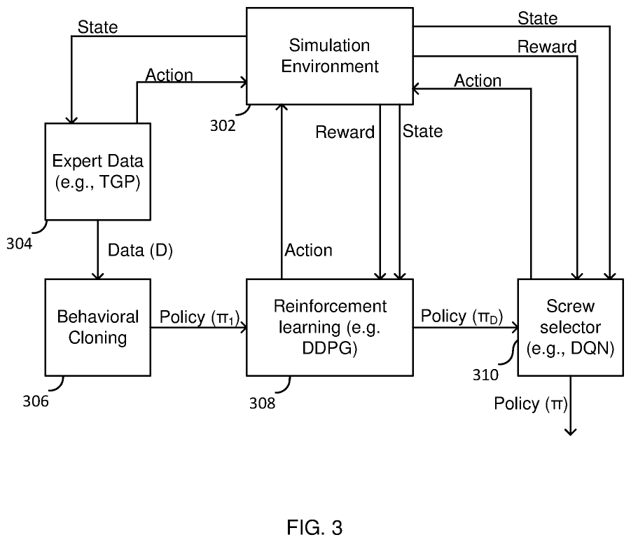

FIG. 3 illustrates a block diagram of the imitation learning and reinforcement learning technique, also showing the screw selector. As shown, there is a simulation environment 302, expert data 304, behavioral cloning 306, reinforcement learning 308, and a screw selector 310.

The table below shows the performance of different tuning techniques for 6p2z filter. TGP refers to the expert data mentioned above. DDPG (only) refers to using only reinforcement learning using the DDPG technique. IL-DDPG (without DQN) refers to using imitation learning and reinforcement learning (using the DDPG technique). Finally, IL-DDPG-DQN refers to using imitation learning and reinforcement learning (using the DDPG technique), and additionally using a screw selector (using the DQN technique). The IL-DDPG-DQN combination has a higher success rate and fewer adjustment steps (on average), which leads to shorter total tuning time.

| | | DDPG | IL-DDPG | |
|---|---|---|---|---|
| Technique | TGP | (only) | (without DQN) | IL-DDPG-DQN |
| #Total data | 0 | 149,000 | 73,000 | 257,000 |
| points | | | | |
| Success rate | 97% | 99.36 ± 0.04% | 99.67 ± 0.03% | 99.67 ± 0.77% |
| #Average | 23 | 43 | 44 | 17 |
| screw | | | | |
| adjustments | | | | |

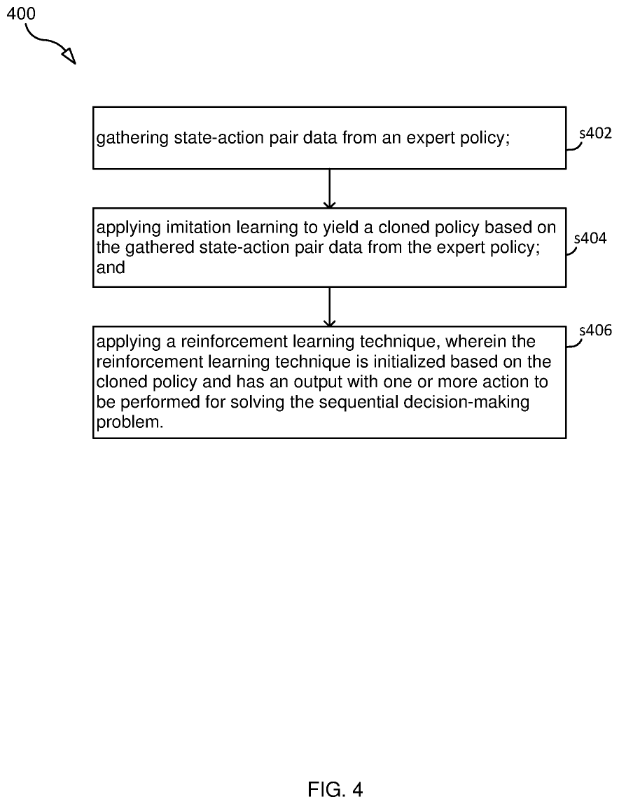

FIG. 4 illustrates a process 400 for solving a sequential decision-making problem according to some embodiments. Process 400 may begin step s402.

Step s402 comprises gathering state-action pair data from an expert policy.

Step s404 comprises applying imitation learning to yield a cloned policy based on the gathered state-action pair data from the expert policy.

Step s406 comprises applying a reinforcement learning technique, wherein the reinforcement learning technique is initialized based on the cloned policy and has an output with one or more action to be performed for solving the sequential decision-making problem.

In embodiments, the imitation learning comprises a behavioral cloning technique. In embodiments, the method further includes applying a screw selector for tuning a screw in a cavity filter, such as a screw selector comprising a Deep Q Network (DQN). In embodiments, the expert policy is based on Tuning Guide Program (TGP). In embodiments, the cloned policy is in the form of a neural network, wherein the deepest hidden layer is convolutional in one dimension. In embodiments, the reinforcement learning technique comprises the Deep Deterministic Policy Gradient (DDPG) technique. In embodiments, an output of the reinforcement learning technique is forced via a multiplied tanh function. In embodiments, applying the reinforcement learning technique comprises allowing the reinforcement learning technique to run for N_{critic} iterations where only the critic network is trained, with no change to the actor network or target network, and after the N_{critic} iterations, allowing the technique to run to convergence. In embodiments, the method further includes performing the one or more actions of the output of the reinforcement learning technique

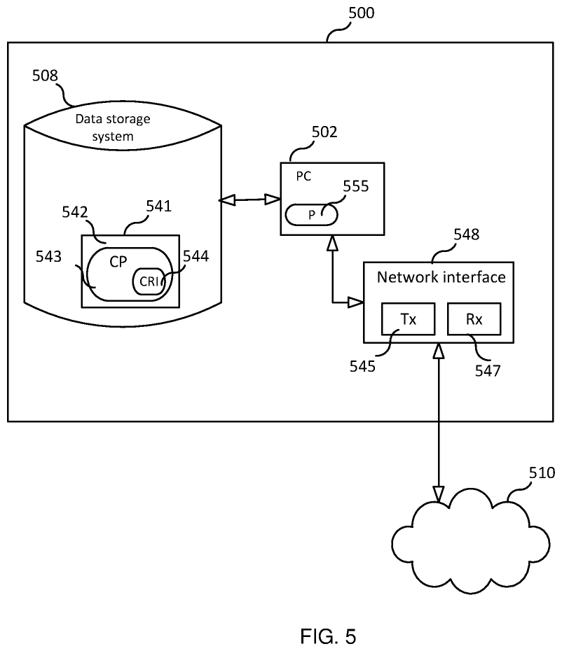

FIG. 5 is a block diagram of an apparatus 500, according to some embodiments. As shown in FIG. 5, the apparatus may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like); a network interface 648 comprising a transmitter (Tx) 545 and a receiver (Rx) 547 for enabling the apparatus to transmit data to and receive data from other nodes connected to a network 510 (e.g., an Internet Protocol (IP) network) to which network interface 548 is connected; and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes the apparatus to perform steps described herein (e.g., steps described herein with reference to the flow charts). In other embodiments, the apparatus may be configured to perform steps described herein without the need for code. That is, for example, PC 502 may consist merely of one or more ASICs. Hence, the features of the embodiments described herein may be implemented in hardware and/or software.

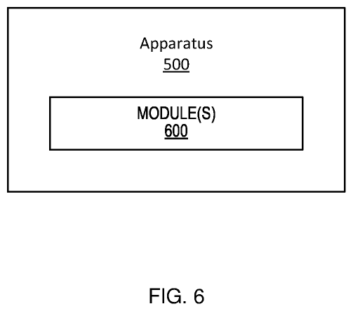

FIG. 6 is a schematic block diagram of the apparatus 500 according to some other embodiments. The apparatus 500 includes one or more modules 600, each of which is implemented in software. The module(s) 600 provide the functionality of apparatus 500 described herein (e.g., the steps herein, e.g., with respect to FIG. 4).

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for solving a sequential decision-making problem, the method comprising:
gathering state-action pair data from an expert policy;
applying imitation learning to yield a cloned policy based on the gathered state-action pair data from the expert policy; and
applying a reinforcement learning technique, wherein the reinforcement learning technique is initialized based on the cloned policy and has an output with one or more action to be performed for solving the sequential decision-making problem.

2. The method of claim 1, wherein the imitation learning comprises a behavioral cloning technique.

3. The method of claim 1, wherein the sequential decision-making problem for solving comprises cavity filter tuning and the method further comprises applying a screw selector for tuning a screw in a cavity filter.

4. The method of claim 3, wherein the screw selector comprises a Deep Q Network (DQN).

5. The method of claim 1, wherein the expert policy is based on Tuning Guide Program (TGP).

6. The method of claim 1, wherein the cloned policy is in the form of a neural network, wherein the deepest hidden layer is convolutional in one dimension.

7. The method of claim 1, wherein the reinforcement learning technique comprises the Deep Deterministic Policy Gradient (DDPG) technique.

8. The method of claim 1, wherein the output of the reinforcement learning technique is forced via a multiplied tanh function.

9. The method of claim 1, wherein applying the reinforcement learning technique comprises allowing the reinforcement learning technique to run for N_{critic} iterations where only a critic network is trained, with no change to an actor network or a target network, and after the N_{critic} iterations, allowing the technique to run to convergence.

10. The method of claim 1, further comprising performing the one or more actions of the output of the reinforcement learning technique.

11. A node for solving a sequential decision-making problem, the node comprising:
a data storage system; and
a data processing apparatus comprising a processor, wherein the data processing apparatus is coupled to the data storage system, and the data processing apparatus is configured to:
gather state-action pair data from an expert policy;
apply imitation learning to yield a cloned policy based on the gathered state-action pair data from the expert policy; and
apply a reinforcement learning technique, wherein the reinforcement learning technique is initialized based on the cloned policy and has an output with one or more action to be performed for solving the sequential decision-making problem.

12. The node of claim 11, wherein the imitation learning comprises a behavioral cloning technique.

13. The node of claim 11, wherein the sequential decision-making problem for solving comprises cavity filter tuning and wherein the data processing apparatus is further configured to apply a screw selector for tuning a screw in a cavity filter.

14. The node of claim 13, wherein the screw selector comprises a Deep Q Network (DQN).

15. The node of claim 11, wherein the expert policy is based on Tuning Guide Program (TGP).

16. The node of claim 11, wherein the cloned policy is in the form of a neural network, w herein the deepest hidden layer is convolutional in one dimension.

17. The node of claim 11, wherein the reinforcement learning technique comprises the Deep Deterministic Policy Gradient (DDPG) technique.

18. The node of claim 11, wherein an output of the reinforcement learning technique is forced via a multiplied tanh function.

19. The node of claim 11, wherein applying the reinforcement learning technique comprises allowing the reinforcement learning technique to run for N_{critic} iterations where only the critic network is trained, with no change to the actor network or target network, and after the N_{critic} iterations, allowing the technique to run to convergence.

20. The node of claim 11, wherein the data processing apparatus is further configured to perform the one or more actions of the output of the reinforcement learning technique.

21-23. (canceled)
